(19) United States
(12) Patent Application Publication
(10) Pub. No.: US 2004/0114860 A1
(43) Pub. Date: Jun. 17, 2004

(54) Optical system for injection of light from a light source into a medium

(76) Inventors: Wolfgang Dultz, Frankfurt am Main (DE); Bernhard Hils, Koenigstein (DE); Heidrun Schmitzer, Cincinnati, OH (US); Walter Heitmann, Gross-Bieberau (DE)

Correspondence Address: KENYON & KENYON, ONE BROADWAY, NEW YORK, NY, 10004, US

(21) Appl. No.: 10/470,023

(22) PCT Filed: Jan. 14, 2002
(86) PCT No.: PCT/EP02/00273

(30) Foreign Application Priority Data
Jan. 20, 2001 (DE) 101 02 592.0

(51) Int. Cl. G02B 6/26; G02B 6/32

(52) U.S. Cl. 385/31; 385/33

(57) ABSTRACT

The present invention is directed to an optical system for coupling light from a light source into a medium, in particular into an optical fiber. The optical system has at least one light-deflecting surface, which directs the light by reflection or refraction into the medium. The form of the light-deflecting surface is such that the light source is not sharply imaged in the medium or on its surface. The optical system according to the present invention can advantageously be used for coupling light of a very high intensity into the medium without the risk of a too high, local luminous density producing non-linear optical effects or resulting in material damage.

### FIELD OF THE INVENTION

The present invention is directed to an optical system for coupling light from a light source into a medium, in particular into an optical fiber.

### BACKGROUND OF THE INVENTION

When traversing a medium, light suffers losses in its intensity due to absorption, the radiant energy of the absorbing component of the light being converted into thermal energy. In the process, the spatial power density of the thereby induced internal heating of the medium rises both with the absorption coefficient as well as with the light intensity, so that the medium is heated up more vigorously in regions of higher light intensity than in regions of lower light intensity.

When light intensity reaches a certain level, undesired effects, such as non-linear optical effects, internal stresses, or material damage to the medium can occur, for example melting, vaporization and chemical decomposition processes. This danger arises, in particular, when light is focused using light-collecting optical elements, such as lenses, in the interior of the medium, creating a spot or a narrow zone of greatly increased light intensity in the medium.

For that reason, when high-intensity light, such as laser light, is coupled into a medium, it is often critically important to prevent regions of too high light intensity from forming within the medium. An important example of this is the coupling of high-intensity light, such as laser light, into optical fibers.

One application of optical fibers of fused quartz or other materials, into which high-intensity light is coupled, is, for example, the transmission of high laser-light intensities for cutting, boring, or other kinds of machining of workpieces. Another application of optical fibers, into which high-intensity light is coupled, is the transmission of information.

Optical fibers have very diverse applications due to their large bandwidth for transmitting information, for example over the long-distance transmission links used in telecommunications. Optical fibers are also being increasingly laid in connection networks all the way to the end consumer in the household.

To keep costs low, multi-mode optical fibers of plastic have been developed to replace the quartz single-mode fibers predominately used in the past. They are intended for use either in the visible spectral region, in the near infrared or, in the future, also in the second optical window (1.3 micrometers).

The advantages of plastic optical fibers are the ease of the laying technique, as well as the availability of inexpensive interconnection techniques. On the other hand, there is the disadvantage of high attenuation, i.e., heavy absorption of the injected light. Therefore, the highest possible intensities should be used when injecting into the plastic optical fibers, in order to obtain light signals which can still be reliably detected at the output of the fibers.

However, as already explained above, the high intensities required can damage the plastic optical fibers, for example cause them to melt and, as a result, destroy the communication link.

Related-art methods provide for coupling high-intensity light into an optical fiber by placing a collective lens for coupling light into the medium, in front of the end face of the optical fiber, to focus the light from the light source into the optical fiber. After passing through the collective lens and the end face of the optical fiber, the light coming from the light source, e.g., laser or laser diode, falls at a multiplicity of angles on the cylindrical side wall of the optical fiber. In this context, to the extent that is possible, the relative aperture of the lens, as well as the configuration of the lens and light source are selected as a function of the refractive indices of the core and of the cladding of the optical fiber in such a way that all of these angles, at which the light impinges upon the cylindrical boundary surface between the core and the cladding, meet the condition of total reflection there.

The drawback in this connection is, however, that they have a focal point. Thus, the light source, e.g., the laser is sharply imaged to the inside of the medium, causing a substantial optical power density to prevail at the location of the image in the medium, which leads to localized heating of the medium and can result in the above-mentioned disadvantageous effects, in particular destruction of the optical fiber. In addition, as already mentioned above, a substantial optical power density can trigger non-linear optical effects and thereby interfere with the transmission of information over the optical fibers.

These disadvantageous effects limit the maximum injectable intensity and are significant, particularly in the context of plastic optical fibers, due to the higher absorption coefficient.

Another way to couple light into a medium, for example into an optical fiber, is, of course, to position the light source in front of the end face of the optical fiber, without using any optical system whatsoever, and to illuminate the end face directly with the light from the light source. In so doing, the light source is not imaged in the medium, so that no zone of extremely high intensity concentration forms. The drawback here, however, is that neither the distribution of the light intensity in the medium nor the distribution of the light incidence angle into the medium can be adapted to the particular requirements. This disadvantage is of serious importance when coupling light into multi-mode optical fibers, in particular.

### TECHNICAL OBJECTIVE

The object underlying the present invention is, therefore, to provide an optical system for coupling light from a light source into a medium which will reduce the spatial optical power density occurring at a maximum in the medium, in comparison with known methods heretofore, without reducing the integrally injected optical power, making possible a predefined distribution of the light incidence angle into the medium.

This objective is achieved in accordance with the present invention by an optical system for coupling light from a light source into a medium. The optical system has at least one light-deflecting surface which directs the light by reflection or refraction into the medium, for the purpose of reducing the spatial luminous density occurring at a maximum in the medium, the form of the light-deflecting surface or surfaces being such that no sharp image of the light source is formed in the medium or on its surface.

The medium may be, in particular, an optical fiber. In this case, the objective is also achieved by an optical system for coupling light from a light source into an optical waveguide, in particular an optical fiber, having at least one light-deflecting surface, which directs the light by reflection or refraction into the medium in such a way that light is injected into the optical waveguide at such angles that light is conducted in the optical waveguide, characterized by such a form of the light-deflecting surface or surfaces that, in order to reduce the spatial luminous density maximally occurring in the optical waveguide or on its surface, no sharp image of the light source is formed.

The form of the light-deflecting surface or surfaces may, in particular, be such that no point of the light source is sharply imaged in the medium or on its surface.

One essential advantage of the present invention is that the distribution of the light intensity in the medium, as well as the distribution of the light incidence angle into the medium may be adapted to any existing requirements by properly selecting the form of the light-deflecting surface or surfaces, and be optimized, without reducing the integral luminous flux. In particular, the present invention makes it possible to prevent an extreme concentration of the light intensity within a small zone.

The optical system in accordance with the present invention may advantageously be, in particular, an axicon, or have such an axicon. “Axicon” refers to rotationally symmetric optical systems which image a point source situated in their optical axis to a point distribution on their optical axis. Thus, an axicon does not have a defined focal length. An example of an axicon is a cone whose axis coincides with the light incidence direction. The articles, “The Axicon: A New Type of Optical Element”, Journal of the Optical Society of America, volume 44 (1954), pp. 592-597, by J. H. McLeod, and “Axicons and Their Use”, Journal of the Optical Society of America, volume 50 (1960), pp. 166-169, likewise by J. H. McLeod, discuss axicons in detail.

The present invention may be used quite advantageously for coupling light into optical waveguides, e.g., optical fibers. Advantageous effects are attained in this case not only by the possibility of avoiding an extreme concentration of the light intensity in the optical waveguide by properly selecting the form of the light-deflecting surface or surfaces, but, in particular, also by the possibility likewise provided by the present invention of optimally adapting the distribution of the light incidence angle into the medium, to existing requirements.

In accordance with the present invention, the form of the light-deflecting surface or surfaces of the optical system may be such that the light emerging from each point of the light source converges upon entry into the medium, each point of the light source not being imaged onto a point, but rather onto an area of finite extent, e.g., onto a line or curve, onto a circle, a surface, or a volume. In other words, a real image of the light source is intentionally formed as an unsharp image.

In accordance with the present invention, an unsharp real image may be formed using an optical system, which does, in fact, bring the light from the light source into convergence in the medium, but, from the outset, is not able to form a sharp image of any one point of an object. Such an optical system may be or include, for example, an aspherical collective lens, which may constitute part of an egg-shaped body, for example.

In addition, in accordance with the present invention, an unsharp real image may be formed by selectively utilizing the image aberrations of focusing, imaging elements. For example, a collective lens or a concave mirror may be used for this purpose, the light source being positioned at such a great distance from the optical axis of the lens that each point of the light source is imaged as a coma. The fact that the comae increase with the object's distance from the optical axis is utilized to advantage here.

In addition, an optical system according to the present invention may be a transparent body delimited by plane surfaces or constitute part of or include such a body. Such a body may be, for example, a prism, a pyramid, an n-hedron (e.g., tetrahedron), or a lens or a mirror having a surface faceted from a multiplicity of individual, plane partial surfaces, i.e., a so-called facet lens or facet mirror. In this case, specific plane surfaces may have a convex or concave curvature to selectively further influence the distribution of the luminous density within the medium, as well as the distribution of the light incidence angle into the medium.

In addition, in accordance with the present invention, the form of the light-deflecting surface or surfaces of the optical system is such that light emerging from each point of the light source diverges upon entry into the medium. This may be achieved, for example, by a diverging lens. Divergence of the light upon entry into the medium may also be attained in that the optical system has a collective lens that images the light source in an image situated completely between the optical system and the surface of the medium or a concave mirror that images the light source in an image situated completely between the optical system and the surface of the medium, so that the light from the light source reaches the medium and diverges again after passing a focal point situated outside of the medium.

In addition, in accordance with the present invention, the form of the light-deflecting surface or surfaces of the optical system is such that the image of each point of the light source is essentially distributed onto a focal line or a focal surface.

Each point of the light source may be imaged onto a focal line, e.g., using a transparent full cone, whose base area or whose tip faces the light source. A full cone directed with its base area to the light source may be embedded in the medium in such a way that its entire lateral surface is in contact with the medium, and its entire base area is not in contact with the medium. In this case, the full cone must have a different refractive index than the medium.

In accordance with the present invention, the optical system may advantageously be produced by a form of the surface of the medium itself functioning as a light-deflecting surface, or have such a form and, thus, be an integral part of the medium. For example, the surface of the medium, for instance the end face of an optical fiber, may have a concave form and, thus, act as a diverging lens.

In addition, an optical system according to the present invention may be or include an internally reflecting hollow tube, whose one opening faces the light source. The hollow tube may have a cylindrical form, for example, or the form of a cone that widens or narrows towards the light source. The cross-sectional shape of the tube may also be other than that of a circle. The function of an internally reflecting cylindrical or conical tube may also be fulfilled by a transparent full cylinder or full cone having an externally reflecting lateral surface. The full cone may be formed by a conically shaped form of the surface of the medium itself. One or both end faces of the full cylinder or of the full cone may have a convex or concave curvature to selectively influence the distribution of the light intensity in the medium, as well as the distribution of the light incidence angle into the medium.

An optical system according to the present invention may also be or include a combination of two or more of the above-mentioned elements. In addition, to selectively influence the distribution of the light intensity in the medium, as well as the distribution of the light incidence angle into the medium, an optical system according to the present invention may have one or a plurality of additional lenses or mirrors.

The figures clarified in the following show exemplarily a specific embodiment of the present invention and relate to the important application case of the coupling of light into a step-index optical fiber. The present invention is, of course, also applicable to the coupling of light into all other types of optical waveguides and into all other transparent media.

### BRIEF DESCRIPTION OF THE DRAWING, WHOSE FIGURE SHOW

FIG. 1 for further clarification of the related art, the coupling of light into an optical fiber using a collective lens;

FIG. 2 a specific embodiment of an optical system according to the present invention which is designed as a collective lens;

FIG. 3 a specific embodiment of an optical system according to the present invention which is designed as a collective lens;

FIG. 4 a specific embodiment of an optical system according to the present invention in which the end face of the optical fiber itself has a concave form and, thus, acts as a diverging lens;

FIG. 5 a specific embodiment of an optical system according to the present invention which is designed as an aspherical collective lens;

FIG. 6 a specific embodiment of an optical system according to the present invention which is designed as a toric lens;

FIG. 7 a specific embodiment of an optical system according to the present invention where the end face of the optical fiber is designed as part of a toric lens and, thus, acts as a toric lens;

FIG. 8 a specific embodiment of an optical system according to the present invention which is designed as a collective lens and whose optical axis runs at a great distance from the light source;

FIG. 9 a specific embodiment of an optical system according to the present invention in which the end face of the optical fiber itself has a convex form and, thus, acts as a collective lens, its optical axis running at a great distance from the light source;

FIG. 10 a specific embodiment of an optical system according to the present invention which is designed as a full cone having a base area facing the light source;

FIG. 11 a specific embodiment of an optical system according to the present invention where the full cone from FIG. 10 is embedded in the optical fiber;

FIG. 12 a specific embodiment of an optical system according to the present invention which is designed as a full cone having a tip facing the light source;

FIG. 13 a specific embodiment of an optical system according to the present invention where the end face of the optical fiber is designed as a full conical form;

FIG. 14 a specific embodiment of an optical system according to the present invention where the end face of the optical fiber is itself designed as a hollow conical form;

FIG. 15 a specific embodiment of an optical system according to the present invention which is designed as a convex facet lens;

FIG. 16 a specific embodiment of an optical system according to the present invention which is designed as an internally reflecting hollow tube that is open at the ends;

FIG. 17 a specific embodiment of an optical system according to the present invention which is designed as an internally reflecting hollow cone which is open at the ends and whose smaller opening faces the light source.

All of the figures show schematic cross-sectional representations.

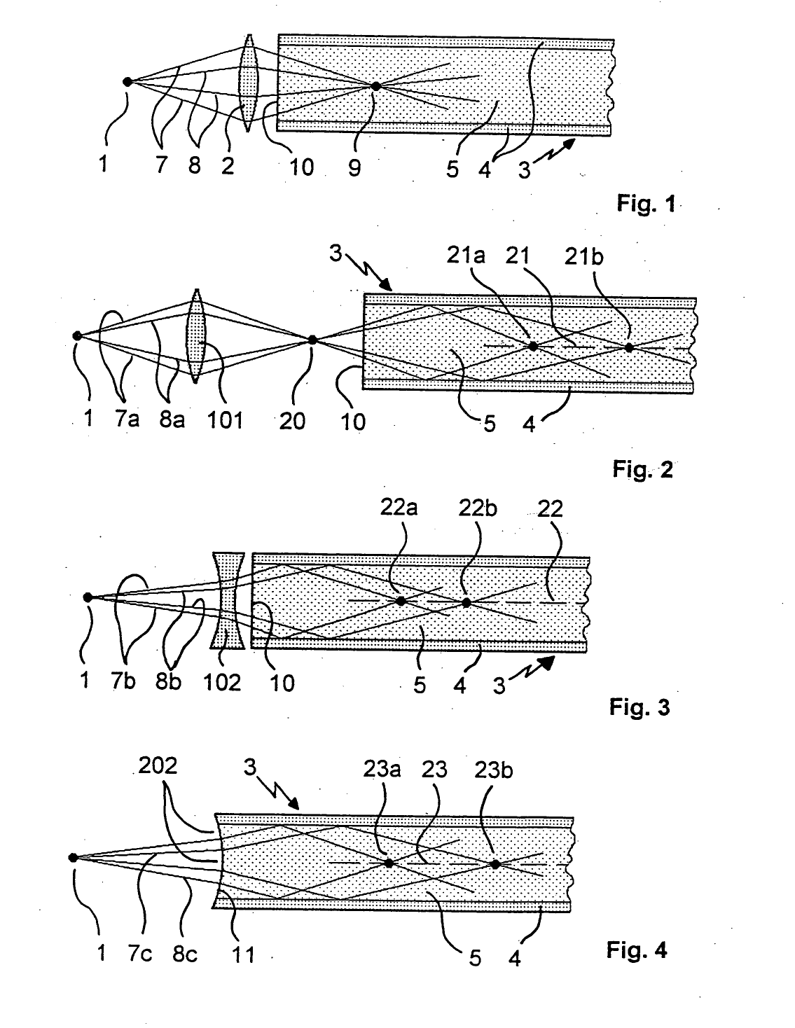

To further elucidate the related art, FIG. 1 shows an example of the coupling of light from a light source 1 into a step-index optical fiber 3. Between light source 1 and end face 10 of optical fiber 3, a collective lens 2 is positioned in such a way that a sharp image 9 is formed of light source 1 within optical fiber 3. Optical fiber 3 is made up of a fiber cladding 4 and a fiber core 5, fiber cladding 4 having a smaller refractive index than fiber core 5, so that a light beam running in fiber core 5 is subjected at the fiber core/fiber cladding boundary surface to a total reflection and may, thus, be conducted in fiber core 5.

Both abaxial light beams 7, as well as paraxial light beams 8 unite in a sharp image 9 of light source 1. The result is that the light intensity is quite high within a narrowly limited zone of optical fiber 3, namely in the region of image 9. When a critical value is exceeded, this can lead to material damage to the optical waveguide and to undesired, non-linear optical effects.

These problems naturally intensify with the injected light intensity. Thus, the maximum light intensity that may still be practically injected is relatively low due to the extreme local concentration of the light intensity in the region of image 9. This is disadvantageous for many optical fiber applications.

FIGS. 2-17 described in the following illustrate, by way of example, various specific embodiments of the present invention used for coupling light into optical fibers. For clarity of the illustration, the light source is positioned in FIGS. 2-17 relatively close to the optical system according to the present invention. However, the light source may, of course, also be situated at a greater distance from the optical system according to the present invention or even lie in infinity. The light source may be a laser, in particular, which emits virtually parallel light.

The optical systems according to the present invention illustrated in the figures are identical in diameter to the optical fibers. Such a choice of diameter is beneficial, however, the optical systems according to the present invention may also have other diameters.

FIG. 2 shows a specific embodiment of an optical system according to the present invention which is designed as a collective lens 101. The light-deflecting surfaces of-the optical system are thus formed in accordance with the present invention by the surfaces of collective lens 101. This lens forms a sharp image 20 of light source 1 that is completely situated between the optical system and end face 10 of optical fiber 3. The light collected by collective lens 101 diverges after passing image 20 and enters as divergent light into optical fiber 3.

As an example of abaxial light beams, a light beam pair 7a is sketched in FIG. 2. After passing through sharp image 20, it arrives in optical fiber 3 and there, after undergoing total [internal] reflection on the inside of fiber cladding 4, intersects at a cross-over point 21a.

The distance of the cross-over point from collective lens 101 is a function of the distance of the light beams from the optical axis of collective lens 101. As an example of paraxial light beams, a light beam pair 8a is sketched in FIG. 2. After passing through sharp image 20, it arrives in optical fiber 3 and there, after undergoing total reflection on the inside of fiber cladding 4, intersects at a cross-over point 21b which does not coincide with cross-over point 21a. A focal line 21 is generated in optical fiber 3, so that, in accordance with the present invention, no point of light source 1 is sharply imaged within optical fiber 3.

Collective lens 101 of FIG. 2 has a biconvex design. Of course, other collective lens designs are also possible, however. For instance, the collective lens may also be plano-convex. In another specific embodiment of the present invention (not shown), the function of collective lens 101 is assumed by a [spherical] concave mirror. Here, as well, a focal line is generated in the optical fiber, so that, in accordance with the present invention, no point of light source 1 is sharply imaged within optical fiber 3.

FIG. 3 shows a specific embodiment of an optical system according to the present invention that is designed as a diverging lens 102. Thus, the light-deflecting surfaces of the optical system are formed in accordance with the present invention by the surfaces of diverging lens 102. In accordance with the present invention, the light from light source 1 is coupled as divergent light into optical fiber 3. Due to total reflection on the inside of fiber cladding 4, abaxial light beam pair 7b intersects at a cross-over point 22a, and the more paraxial light beam pair 8b at a cross-over point 22b; a focal line 22 is generated in optical fiber 3, so that, in accordance with the present invention, no point of light source 1 is sharply imaged within optical fiber 3. Diverging lens 102 of FIG. 3 has a biconcave design. Of course, other diverging lens designs are also possible, however. For instance, the diverging lens may also be plano-concave.

In another specific embodiment of the present invention (not shown), before entering the optical fiber, light from the light source is brought to divergence by a convex mirror; thus, here, the convex mirror fulfills the function of diverging lens 102 of FIG. 3. In this case, the light-deflecting surface of the optical system in accordance with the present invention is formed by the surface of the convex mirror.

FIG. 4 shows a specific embodiment of an optical system according to the present invention where end face 11 of optical fiber 3 itself has a concave form 202 and, thus, acts as a diverging lens. The optical system according to the present invention is, therefore, an integral part of the medium. In this context, the light-deflecting surface of the optical system is formed in accordance with the present invention by the surface of concave form 202. Thus, the light from light source 1 is coupled as divergent light into optical fiber 3. Due to total reflection on the inside of fiber cladding 4, abaxial light beam pair 7c intersects at a cross-over point 23a, and the more paraxial light beam pair 8c at a cross-over point 23b; a focal line 23 is generated in optical fiber 3, so that, in accordance with the present invention, no point of light source 1 is sharply imaged within optical fiber 3.

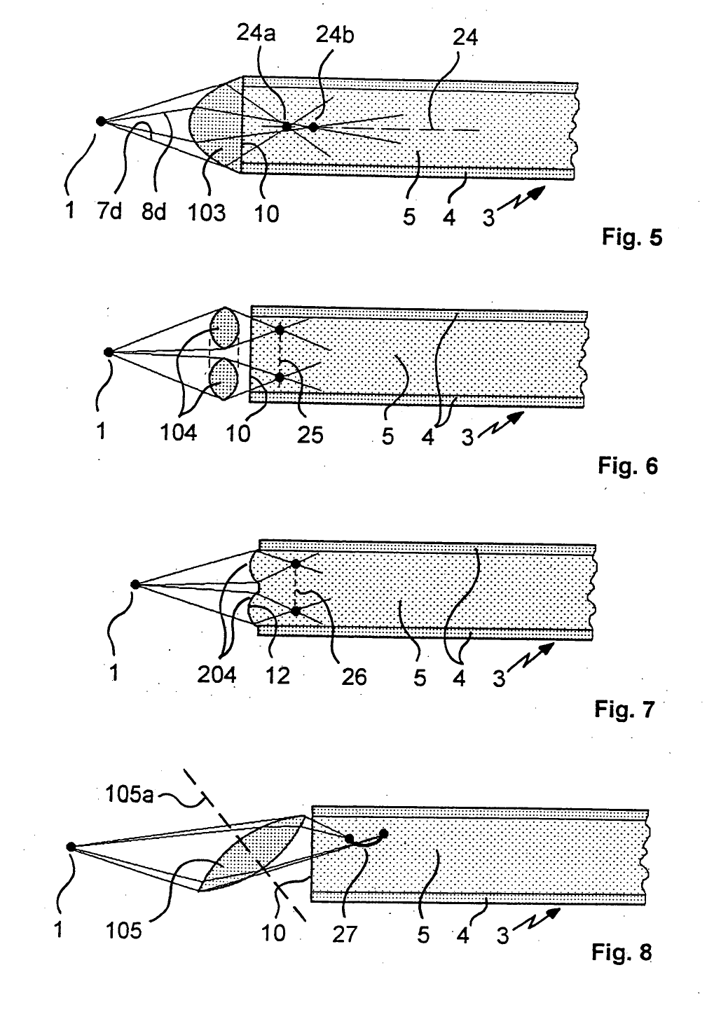

FIG. 5 shows a specific embodiment of an optical system according to the present invention which is designed as an aspherical collective lens 103. The light-deflecting surfaces of the optical system are thus formed in accordance with the present invention by the surfaces of aspherical collective lens 103. The focal length of such a lens is a function of the interaxis distance, so that the light coupled into optical fiber 3 does, in fact, converge, but, in accordance with the present invention, not on a focal point or a sharp image of light source 1, but rather along a focal line 24. The abaxial light beam pair 7d intersects, for example, on focal line 24 at a cross-over point 24a, and the more paraxial light beam pair 8d on focal line 24 at a cross-over point 24b which does not coincide with cross-over point 24a.

Of course, aspherical lens 103—in a different way than shown in FIG. 5—may be spaced apart from end face 10 of optical fiber 3. In another specific embodiment (not shown), the end face of the optical fiber is designed as an aspherical convex form which functions as an aspherical collective lens. The optical system according to the present invention is, therefore, an integral part of the medium. In this context, the light-deflecting surface of the optical system is formed in accordance with the present invention by the surface of the aspherical convex form. Here, as well, a focal line is generated in the optical fiber, so that, in accordance with the present invention, no point of light source 1 is sharply imaged within optical fiber 3.

FIG. 6 shows a specific embodiment of an optical system according to the present invention which is designed as a toric lens 104, so that the light from light source 1 coupled into optical fiber 3 does, in fact, converge, but, in accordance with the present invention, does not unite in one point or sharp image of light source 1, but rather in a focal circle 25, which runs in one plane normally to the optical axis of toric lens 104, so that, in accordance with the present invention, no point of light source 1 is sharply imaged within optical fiber 3. The light-deflecting surfaces of the optical system are, thus, formed in accordance with the present invention by the surfaces of toric lens 104.

FIG. 7 shows a specific embodiment of an optical system according to the present invention where end face 12 of optical fiber 3 itself has a toroidal form 204, namely as part of a toric lens, and, thus, acts as a toric lens. The optical system according to the present invention is, therefore, an integral part of the medium. The light-deflecting surface of the optical system is, therefore, formed in accordance with the present invention by the surface of toroidal form 204. Thus, the light from light source 1 is coupled as converging light into optical fiber 3 and unites there in a focal circle 26, so that, in accordance with the present invention, no point of light source 1 is sharply imaged within optical fiber 3.

FIG. 8 shows a specific embodiment of an optical system according to the present invention which is designed as a collective lens 105 and whose form is such that its optical axis 105a runs at such a great distance from light source 1 that the light from light source 1 coupled into optical fiber 3 does, in fact, converge, but, in accordance with the present invention, does not unite in a point or a sharp image of light source 1, but rather in a coma 27. The light-deflecting surfaces of the optical system are thus formed in accordance with the present invention by the surfaces of collective lens 105. Since concave mirrors are also afflicted with the aberration whereby abaxial object points are imaged as comae, the function of collective lens 105 may also be fulfilled by a concave mirror whose optical axis runs at a great distance from the light source. In this case, the light-deflecting surface of the optical system in accordance with the present invention is formed by the concave surface of the concave mirror.

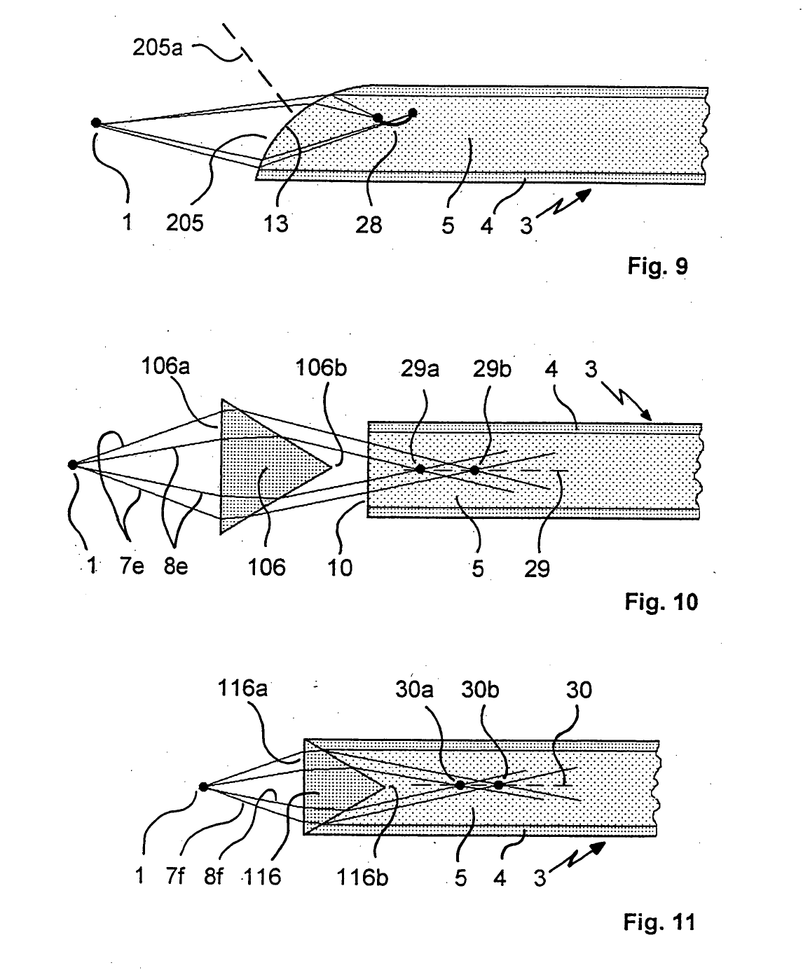

FIG. 9 shows a specific embodiment of an optical system according to the present invention where end face 13 of optical fiber 3 itself has a convex form 205 and, thus, acts as a collective lens, convex form 205 being designed in such a way that its optical axis runs at a great distance from the light source. Thus, the light from light source 1 is coupled as converging light into optical fiber 3 and unites there in a coma 28, so that, in accordance with the present invention, no point of light source 1 is sharply imaged within optical fiber 3. The optical system according to the present invention is, therefore, an integral part of the medium. In this context, the light-deflecting surface of the optical system is formed in accordance with the present invention by surface 13 of convex form 205.

FIG. 10 shows a specific embodiment of an optical system according to the present invention which is designed as a full cone 106, with base surface 106a facing the light source, so that the light from light source 1 coupled into optical fiber 3 does, in fact, converge, but, in accordance with the present invention, does not unite in a point or a sharp image of light source 1, but rather in a focal line 29. The light-deflecting surfaces of the optical system are thus formed in accordance with the present invention by the surfaces of full cone 106. The abaxial light beam pair 7e intersects, for example, on focal line 29 at a cross-over point 29a, and the more paraxial light beam pair 8e on focal line 29 at a cross-over point 29b which does not coincide with cross-over point 29a.

In another specific embodiment (FIG. 11), a full cone 116 is embedded in such a way in optical fiber 3 that its entire lateral surface 116b is in contact with the fiber-optic material and its entire base area 116a is not in contact with the fiber-optic material. For this purpose, optical fiber 3 is cut out hollow-conically in the area of its end face. The cut-out accommodates full cone 116. In this specific embodiment of the present invention, the refractive indices of the full-cone material and those of the fiber core material must be different. FIG. 11 illustrates the case where the refractive index of the full-cone material is higher than that of the fiber core material. A focal line 30 is formed in the optical fiber. The abaxial light beam pair 7f intersects, for example, on focal line 30 at a cross-over point 30a, and the more paraxial light beam pair 8f on focal line 30 at a cross-over point 30a which does not coincide with cross-over point 30a. In accordance with the present invention, no point of light source 1 is sharply imaged within optical fiber 3.

In another specific embodiment (not shown), the refractive index of the full-cone material is lower than that of the fiber-core material. Due to the total reflection on the inside of the fiber cladding, a focal line is formed in this case as well in the optical fiber, so that, in accordance with the present invention, no point of light source 1 is sharply imaged within optical fiber 3. In another specific embodiment (not shown), instead of full cone 106, a full pyramid is used whose base surface faces the light source. To further selectively influence or optimize the distribution of the light incidence angle into optical fiber 3, the base surfaces of full cone 3 and of the full pyramids may have a convex or concave curvature.

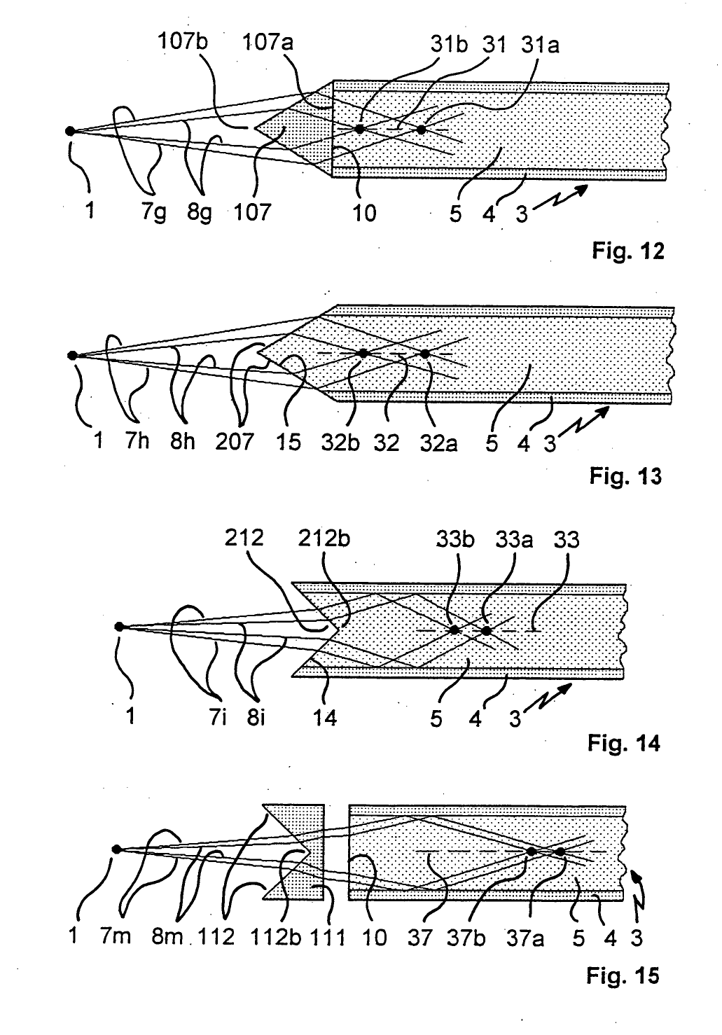

FIG. 12 shows a specific embodiment of an optical system according to the present invention which is designed as a full cone 107, with tip 107b facing the light source, so that the light from light source 1 coupled into optical fiber 3 does, in fact, converge, but, in accordance with the present invention, does not unite in a point or a sharp image of light source 1, but rather in a focal line 31. The light-deflecting surfaces of the optical system according to the present invention are thus formed by the surfaces of full cone 107. The abaxial light beam pair 7g intersects, for example, on focal line 31 at a cross-over point 31a, and the more paraxial light beam pair 8g on focal line 31 at a cross-over point 31b which does not coincide with cross-over point 31a.

Base surface 107a of full cone 107 may, as shown in FIG. 12, be in contact with end face 10 of optical fiber 3, or it may be spaced apart from the same. The base surface of full cone 107 may be plane, or have a concave or convex curvature. In another specific embodiment (not shown), instead of full cone 107, a full pyramid is used whose tip faces the light source and whose base surface may likewise be curved.

FIG. 13 illustrates a specific embodiment of an optical system according to the present invention where end face 15 of optical fiber 3 is designed as a full conical form 207, so that the light from light source 1 coupled into optical fiber 3 is united in a focal line 32. The optical system according to the present invention is, therefore, an integral part of the medium. In this context, the light-deflecting surface of the optical system is formed in accordance with the present invention by cladding surface 15 of full-conical form 207. The abaxial light beam pair 7h intersects, for example, on focal line 32 at a cross-over point 32a, and the more paraxial light beam pair 8h on focal line 32 at a cross-over point 32b which does not coincide with cross-over point 32a. In accordance with the present invention, no point of light source 1 is sharply imaged within optical fiber 3.

In another specific embodiment (not shown), instead of full-conical form 207, a full-pyramid form is used as a light-deflecting surface. Here as well, the optical system according to the present invention is an integral part of the medium.

FIG. 14 illustrates a specific embodiment of an optical system according to the present invention where end face 14 of optical fiber 3 is designed as a hollow conical form 212 whose tip 212b faces away from light source 1, so that the light from light source 1 coupled into optical fiber 3 is united in a focal line 33. The optical system according to the present invention is, therefore, an integral part of the medium. In this context, the light-deflecting surface of the optical system is formed in accordance with the present invention by the surface of hollow conical form 212. The abaxial light beam pair 7i intersects, for example, on focal line 33 at a cross-over point 33a, and the more paraxial light beam pair 8i on focal line 33 at a cross-over point 33b which does not coincide with cross-over point 33a. In accordance with the present invention, no point of light source 1 is sharply imaged within optical fiber 3.

In another specific embodiment (not shown), instead of full-conical form 212, a full-pyramid form is used as a light-deflecting surface.Here as well, the optical system according to the present invention is an integral part of the medium.

FIG. 15 shows a specific embodiment of an optical system according to the present invention that is constituted of a cylinder 111 having a hollow-conical cut-out 112, whose tip 112b faces away from light source 1. The light from light source 1 coupled into optical fiber 3 is united in a focal line 37. The abaxial light beam pair 7m intersects, for example, on focal line 37 at a cross-over point 37a, and the more paraxial light beam pair 8m on focal line 37 at a cross-over point 37b which does not coincide with cross-over point 37a. In accordance with the present invention, no point of light source 1 is sharply imaged within optical fiber 3.

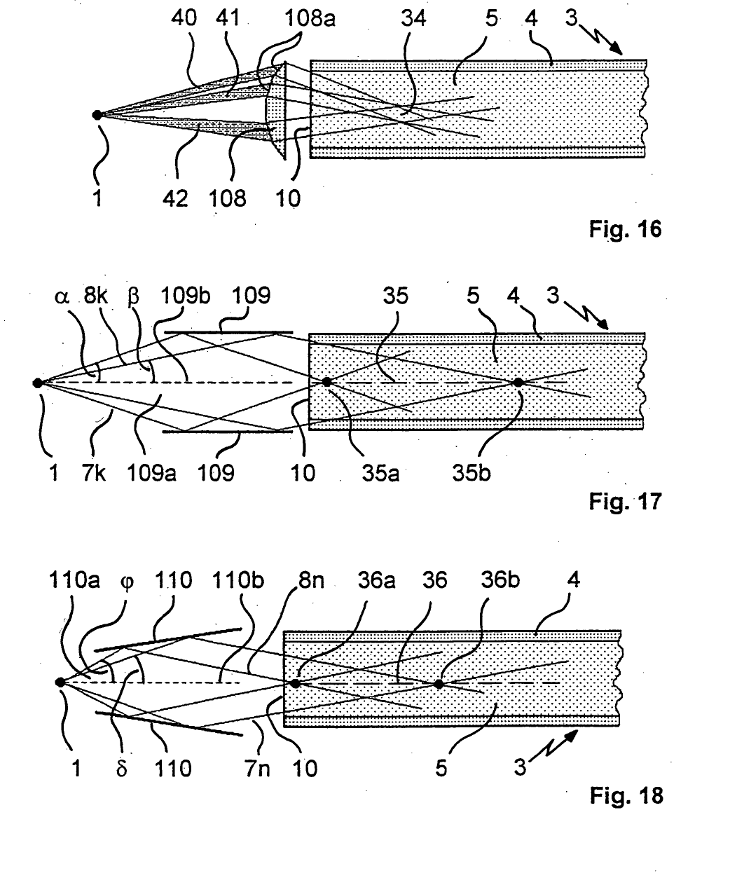

FIG. 16 illustrates a specific embodiment of an optical system according to the present invention that is designed as a plano-convex lens 108 whose convex surface is faceted from a multiplicity of individual plane partial surfaces 108a, so that plano-convex lens 108 is a facet lens. Thus, the light-deflecting surfaces of the optical system are formed in accordance with the present invention by the surfaces of facet lens 108. Here as well, the light from light source 1 coupled into optical fiber 3 converges. However, in accordance with the present invention, this light is not concentrated in one point or a sharp image of light source 1, but rather in a finite spatial volume 34, whose dimensions are dependent on the size, shape, and alignment of the individual plane partial surfaces 108a. For illustration purposes, three beams of rays 40, 41, 42 are sketched in FIG. 15. They are refracted by various plane partial surfaces of facet lens 108 and intersect within spatial volume 34.

In another specific embodiment (not shown), the facet lens has a biconvex design. The function of the biconvex or plano-convex facet lens may also be fulfilled by a hollow mirror, whose concave surface is faceted from a multiplicity of individual plane partial surfaces.

In another specific embodiment (not shown), the facet lens has a plano-concave or biconcave design. In yet another specific embodiment (not shown), the end face of optical fiber 3 is faceted in a convex or concave form, so that the end face functions as a convex or concave facet lens. Here as well, the optical system according to the present invention is an integral part of the medium.

In accordance with another specific embodiment of the present invention (not shown), an optical system according to the present invention may be designed as a convex-cylindrical lens, so that the light from light source 1 coupled into optical fiber 3 converges. However, in accordance with the present invention, this light is not imaged onto a point or a sharp image of light source 1, but rather onto a focal line which runs normally to the optical axis of the convex-cylindrical lens. In accordance with the present invention, in the process, no point of light source 1 is sharply imaged within optical fiber 3. In another specific embodiment (not shown), the function of the convex-cylindrical lens is fulfilled by a cylindrical concave mirror.

In accordance with another specific embodiment of the present invention (not shown), an optical system according to the present invention may be designed as a concave-cylindrical lens, so that the light from light source 1 coupled into optical fiber 3 diverges upon entry into optical fiber 3. In another specific embodiment (not shown), the function of the concave-cylindrical lens is fulfilled by a convex-cylindrical mirror. In yet another specific embodiment (not shown), the end face of optical fiber 3 is designed as a convex-cylindrical or concave-cylindrical form, so that the end face itself functions as a convex or concave cylindrical lens, and the optical system in accordance with the present invention is an integral part of the medium. In these cases as well, in accordance with the present invention, no point of light source 1 is sharply imaged within optical fiber 3.

FIG. 17 illustrates a specific embodiment of an optical system according to the present invention which is designed as an internally reflecting hollow tube 109 which is open at the ends and whose opening 109a faces the light source. The light-deflecting surface of the optical system is, therefore, formed in accordance with the present invention by the inner surface of hollow tube 109. Total reflection takes place both at the inner wall of tube 109, as well as at the inner surface of fiber cladding 4. For that reason, in accordance with the present invention, the light from light source 1 coupled into optical fiber 3 is not united in one point or one sharp image of light source 1, but rather on a focal line 35. Light beams 8k, which run at an angle b to tubular axis 109b, intersect on focal line 35 at a cross-over point 35b. Light beams 7k, which run at an angle a to tubular axis 109b, intersect on focal line 35 at a cross-over point 35a which does not coincide with cross-over point 35b.

FIG. 18 illustrates a specific embodiment of an optical system according to the present invention which is designed as an internally reflecting hollow tube 110 which is open at the ends and whose smaller opening 110a faces light source 1. Thus, the light-deflecting surface of the optical system is formed in accordance with the present invention by the inner surface of hollow cone 110. Total reflection takes place both at the inner wall of hollow cone 110, as well as at the inner surface of fiber cladding 4. For that reason, in accordance with the present invention, the light from light source 1 coupled into optical fiber 3 is not united in one point or one sharp image of light source 1, but rather on a focal line 36. Light beams 8n, for example, which run at an angle j to conical axis 110b, intersect on focal line 36 at a cross-over point 36b. Before impinging upon the inner cone surface at an angle d to conical axis 110b, light beams 7n, for example, intersect on focal line 36 at a cross-over point 36a which does not coincide with cross-over point 36b.

The distribution of the light incidence angles into the medium is able to be advantageously optimized by appropriately selecting the opening angle of the cone.

In accordance with another specific embodiment of the present invention (not shown), an optical system according to the present invention may be designed as an internally reflecting hollow cone, whose ends are open and whose larger opening faces the light source. Here as well, the inner wall of the hollow cone acts as a light-deflecting surface. In this case as well, the light from the light source coupled into the optical fibers is united in a focal line, so that, in accordance with the present invention, no point of light source 1 is sharply imaged within optical fiber 3.

In accordance with other specific embodiments of the present invention (not shown), an optical system according to the present invention may be designed as a transparent full cylinder having an externally reflecting lateral surface, whose one end face faces the light source. The inner side of the lateral surface of the full tube or full cone acts as a light-deflecting surface.

For the purpose of selectively influencing the light incidence angles into the optical fibers, one or both end faces [of the] full cone or full cylinder may have a convex or concave curvature. In addition, the full cone may be formed by a conical form of the end face of the optical fiber itself. In these cases as well, the light from the light source coupled into the optical fiber is united in a focal line. In these cases as well, in accordance with the present invention, no point of light source 1 is sharply imaged within optical fiber 3.

For purposes of further influencing or optimizing the distribution of the light incidence angles into the optical fiber, an optical system according to the present invention may have one or more additional lenses. In addition, various specific embodiments of the present invention may be combined with one another.

Industrial Applicability:

The present invention has industrial application, in particular, for the coupling of optical signals into optical fibers, for example, for data-transmission purposes.

The key figure is FIG. 10.

Reference Symbol List

1 light source

2 collective lens

3 optical fiber

4,5 cladding, core from 3

6 light from 1

7, 7a-m abaxial light beam pairs

8, 8a-m more paraxial light beam pairs

9,20 sharper images of 1

10-15 end faces

21-24, 29-33, 35-37 focal lines

21a-24a, 29a-33a, cross-over points of 7a-m

35a-37a 21b-24b, 29b-33b, cross-over points of 8a-m

35b-37b 25,26 focal circles

27,28 comae

34 spatial volumes

40, 41, 42 light beams

101 collective lens

102 diverging lens

103 aspherical collective lens

104 toric lens

105, 105a collective lens, optical axis of the same

106, 107,116 full cone

106a base area of 106

116a, b lateral surface of 116

107a, b base area, tip of 107

108, convex facet lens

108a plane partial surface of 108

109 internally reflecting hollow tube

109a, b opening, axis of 109

110 internally reflecting hollow cone

110a smaller opening of 110

110b axis of 110

111 cylinder

112 hollow-conical cut-out of 111

112b tip of 112

202 concave form

204 toroidal form

205 convex form

205a optical axis of 205

207 full-conical form

212 hollow conical form

212b tip of 212

What is claimed is:

1. An optical system for coupling light from a light source into a medium, comprising at least one light-deflecting surface, which directs the light by reflection or refraction into the medium, wherein for the purpose of reducing the spatial luminous density occurring at a maximum in the medium, the form of the light-deflecting surface or surfaces is such that no sharp image of the light source (1) is formed in the medium (3) or on its surface (10, 11, 12, 13, 14, 15).

2. An optical system for coupling light from a light source into an optical waveguide, in particular an optical fiber, having at least one light-deflecting surface, which directs the light by reflection or refraction into the medium in such a way that light is injected into the optical waveguide at such angles that light is conducted in the optical waveguide (1), characterized by such a form of the light-deflecting surface or surfaces that, in order to reduce the luminous density maximally occurring in the optical waveguide (3) or on its surface (10, 11, 12, 13, 14, 15), no sharp image of the light source (1) is formed.

3. The optical system as recited in claim 1 or 2, wherein the optical system is an integral part of the medium (3) and is produced by a form (202, 204, 205, 207, 212) of the surface (11, 12, 13, 14, 15) of the medium (3) functioning as a light-deflecting surface, or has such a form.

4. The optical system as recited in claim 1 or 2, wherein the light-deflecting surface or surfaces have such that a form that no point of the light source (1) is sharply imaged in the medium (3) or on its surface (10, 11, 12, 13, 14, 15).

5. The optical system as recited in one of claims 1 through 3, wherein the form of the light-deflecting surface or surfaces is such that the image of each point of the light source (1) is essentially a focal line (21-26, 29-33, 35-37) or a focal surface.

6. The optical system as recited in one of claims 1 through 5, wherein the optical system is or has an axicon (103, 106, 107, 109, 110, 116).

7. The optical system as recited in claim 1 or 2, wherein the optical system is or has a collective lens (101) that images the light source (1) in an image situated completely between the optical system and the surface (10) of the medium (3) or a concave mirror that images the light source (1) in an image situated completely between the optical system and the surface (10) of the medium (3).

8. The optical system as recited in claim 1 or 2, wherein the optical system is or has a diverging lens (102) or a convex mirror.

9. The optical system as recited in claim 1 or 2, wherein the surface (11) of the medium is or has a concave form (202) which acts as a diverging lens.

10. The optical system as recited in claim 1 or 2, wherein the optical system is or has a collective lens (103) having at least one aspherical surface.

11. The optical system as recited in claim 3, wherein the optical system is designed as an aspherical, convex form of the surface of the medium (3) functioning as an aspherical collective lens, or has such a form.

12. The optical system as recited in claim 1 or 2, wherein the optical system is or has a toric lens (104).

13. The optical system as recited in claim 3, wherein the optical system is designed as a toroidal form (204) of the surface of the medium (3) functioning as a toric lens, or has such a form (204).

14. The optical system as recited in claim 1 or 2, wherein the optical system is a collective lens (105) or a concave mirror or has such a lens or mirror, the light-deflecting surface or surfaces having such a form that the optical axis (105a) of the collective lens (105) or of the concave mirror runs at such a great distance from light source (1) that each point of the light source (1) is imaged as a coma (27).

15. The optical system as recited in claim 3, wherein the optical system is designed as a convex form (205) of the surface of the medium (3) functioning as a collective lens, or has such a form (205), the light-deflecting surface (13) having such a form that its optical axis (205a) runs at such a great distance from light source (1) that each point of the light source (1) is imaged as a coma (28).

16. The optical system as recited in claim 1 or 2, wherein the optical system is a full cone (106) or has a full cone (106), the base surface (106a) of the full cone (106) facing the light source (1).

17. The optical system as recited in claim 1 or 2, wherein the optical system is a full cone (116) or has a full cone (116), the base surface (116a) of the full cone (116) facing the light source (1), and the full cone (116) having a different refractive index than the medium (3) and being embedded therein in such a way that the entire lateral surface of the full cone (116) is in contact with the medium (3), and the entire base area (116a) is not in contact with the medium (3).

18. The optical system as recited in claim 1 or 2, wherein the optical system is a transparent full cone (107) or is or has a transparent full pyramid, the tip (107b) of the full cone (107) or of the full pyramid facing the light source (1).

19. The optical system as recited in one of claims 16 through 18, wherein the base area of the full cone (106, 107, 116) or of the full pyramid has a convex or concave curvature.

20. The optical system as recited in claim 3, wherein the optical system is formed by a full-conical form (207) or a full-pyramid form of the surface of the medium (3), or has such a form.

21. The optical system as recited in claim 1 or 2, wherein the optical system is constituted of a cylinder (111) having a hollow-conical cut-out (112), or has such a cylinder, the tip (112b) of the hollow-conical cut-out (112) facing away from the light source (1).

22. The optical system as recited in claim 3, wherein the optical system is constituted of a hollow-conical or hollow pyramid-shaped form (212) of the surface (14) of the medium (3) or includes such a form.

23. The optical system as recited in claim 3, wherein the optical system is constituted of a full prismatic or hollow prismatic form of the surface of the medium (3), or has such a form.

24. The optical system as recited in claim 1 or 2, wherein the optical system is a convex or concave lens (108) or a concave mirror having a surface faceted from a multiplicity of individual plane partial surfaces (108a), or has such a lens (108) or such a concave mirror.

25. The optical system as recited in claim 3, wherein the optical system is constituted of a convex or concave form of the surface of the medium (3) faceted from a multiplicity of individual plane partial surfaces, or has such a form, this form functioning as a convex or concave facet lens.

26. The optical system as recited in claim 1 or 2, wherein the optical system is a convex or concave cylindrical lens or a convex or concave cylindrical mirror, or has such a lens or mirror.

27. The optical system as recited in claim 3, wherein the optical system is constituted of a convex-cylindrical or concave-cylindrical form of the surface of the medium (3) functioning as a cylindrical collective lens or cylindrical diverging lens, or has such a form.

28. The optical system as recited in claim 1 or 2, wherein the optical system is or has an internally reflecting hollow tube (109) which is open at the ends and whose one opening (109a) faces the light source (1), the inner wall of the hollow tube (109) acting as a light-deflecting surface.

29. The optical system as recited in claim 1 or 2, wherein the optical system is an internally reflecting hollow cone (110) which is open at the ends, or has such a hollow cone, one opening of the hollow cone (110) facing the light source (1), and the inner wall of the hollow cone (110) acting as a light-deflecting surface.

30. The optical system as recited in claim 1 or 2, wherein the optical system is or has a transparent full cylinder or full cone having an externally reflecting lateral surface, whose one end face faces the light source (1), the inner side of the lateral surface acting as a light-deflecting surface.

31. The optical system as recited in claim 30, wherein one or both end faces of the full cone or full cylinder has/have a convex or concave curvature.

32. The optical system as recited in claim 3, wherein the optical system is constituted of a full-conical form of the surface of the medium (3), or has such a form.

33. The optical system as recited in claim 32, wherein the end face of the full-conical form has a convex or concave curvature.

34. The optical system as recited in one of the claims 1-30, wherein the optical system has at least one additional lens.
